(19) United States
(12) Patent Application Publication
(10) Pub. No.: US 2014/0323042 A1
(43) Pub. Date: Oct. 30, 2014

(54) WATCH WITH WIRELESS COMMUNICATION FUNCTIONALITY

(71) Applicant: Hon Hai Precision Industry Co., Ltd., New Taipei (TW)

(72) Inventors: CHI-HUNG LEE, New Taipei (TW); SHENG-HSIANG LIN, New Taipei (TW)

(73) Assignee: HON HAI PRECISION INDUSTRY CO., LTD., New Taipei (TW)

(21) Appl. No.: 14/136,112

(22) Filed: Dec. 20, 2013

(30) Foreign Application Priority Data
Apr. 24, 2013 (TW) 102114710

(51) Int. Cl. H04B 5/00

(52) U.S. Cl. CPC H04B 5/00
USPC 455/41.1

(57) ABSTRACT

A watch having wireless communication functionality includes an NFC chip, a selecting module electrically connected to the NFC chip, a first NFC antenna electrically connected to the selecting module, and a second NFC antenna alternatively connected to the selecting module. When the second NFC antenna is connected to the selecting module, the selecting module turns on a connection between the second NFC antenna and the NFC chip, and turns off a connection between the first NFC antenna and the NFC chip, so that the second NFC antenna is capable of communicating with an external device. When the second NFC antenna is not connected from the selecting module, the selecting module turns on the connection between the first NFC antenna and the NFC chip, so that the first NFC antenna is capable of communicating with the external device.

### BACKGROUND

1. Technical Field

The present disclosure relates to a watch having wireless communication functionality.

2. Description of Related Art

Near field communication (NFC) is a set of standards for smart phones and similar devices to establish communication with each other by touching them together or bringing them into close proximity, usually no more than a few inches. However, portability of smart phones and similar devices may be low.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a watch having wireless communication functionality.

FIG. 2 is a circuit diagram of the watch of FIG. 1, with a second near field communication (NFC) antenna not connected from the NFC chip.

FIG. 3 is a circuit diagram of the watch of FIG. 1, with the second NFC antenna connected to the NFC chip.

FIG. 4 is an isometric, assembled view of an embodiment of a watch having wireless communication functionality.

FIG. 5 is an exploded view of the watch of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

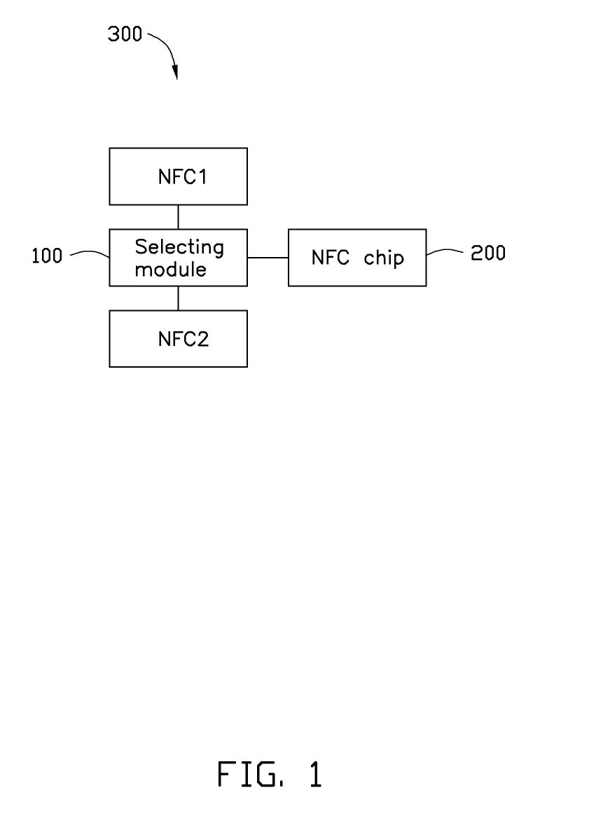

FIG. 1 shows a watch 300 having wireless communication functionality in accordance with one embodiment. The watch 300 includes a first near field communication (NFC) antenna NFC1, a second NFC antenna NFC2, a selecting module 100, and an NFC chip 200.

The selecting module 100 is electrically connected to the NFC chip 200. The first NFC antenna NFC1 and the second NFC antenna NFC2 are each selectively electrically connected to the selecting module 100. The selecting module 100 selects the first NFC antenna NFC1 or the second NFC antenna NFC2 to electrically connect to the NFC chip 200.

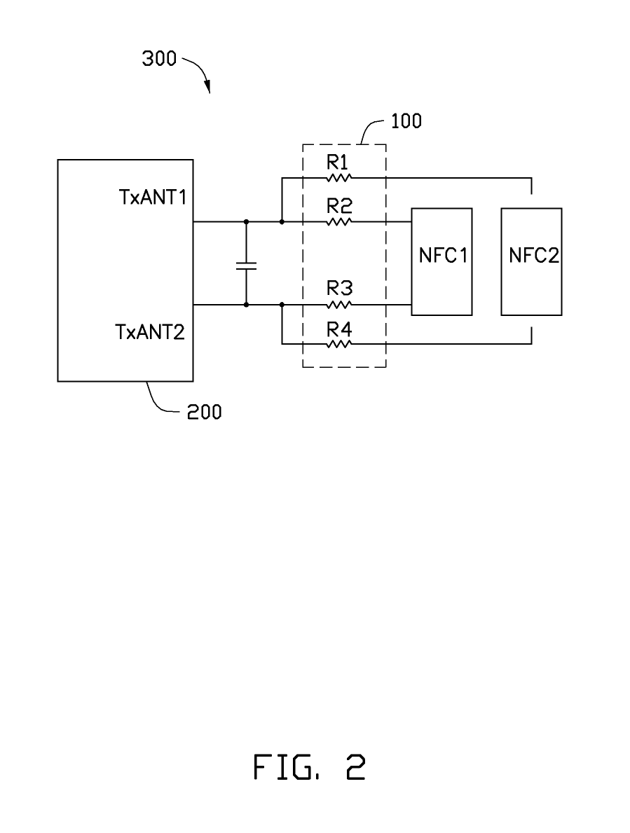

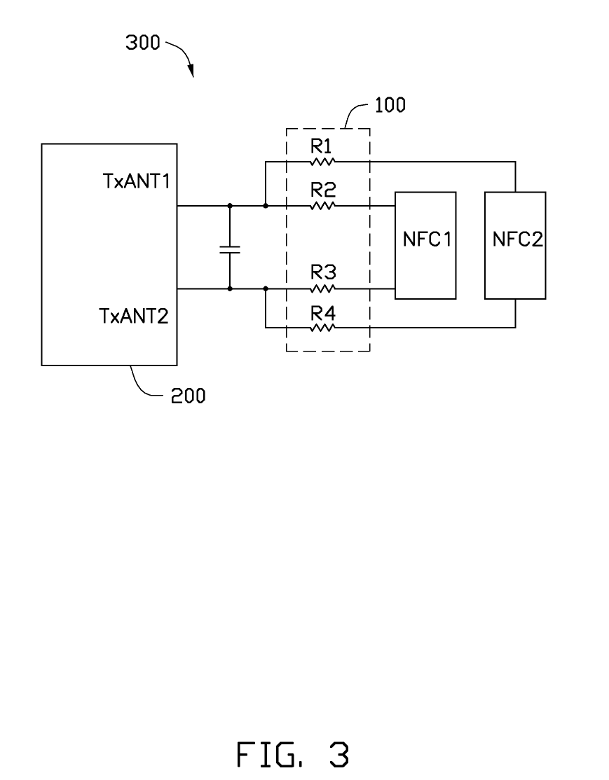

FIGS. 2 to 5 show that the selecting module 100 includes a first resistor R1, a second resistor R2, a third resistor R3, and a fourth resistor R4. The NFC chip 200 includes a first wireless signal transmitting terminal TxANT1 and a second wireless signal transmitting terminal TxANT2. A first terminal of the first NFC antenna NFC1 is electrically connected to the first wireless signal transmitting terminal TxANT1 via the second resistor R2. A second terminal of the first NFC antenna NFC1 is electrically connected to the second wireless signal transmitting terminal TxANT2 via the third resistor R3. When the second NFC antenna NFC2 is connected to the NFC chip 200, a first terminal of the second NFC antenna NFC2 is electrically connected to the first wireless signal transmitting terminal TxANT1 via the first resistor R1, and a second terminal of the second NFC antenna NFC2 is electrically connected to the second wireless signal transmitting terminal TxANT2 via the fourth resistor R4. In one embodiment, resistances of the second resistor R2and the third resistor R3 are greater than resistances of the first resistor R1 and the fourth resistor R4.

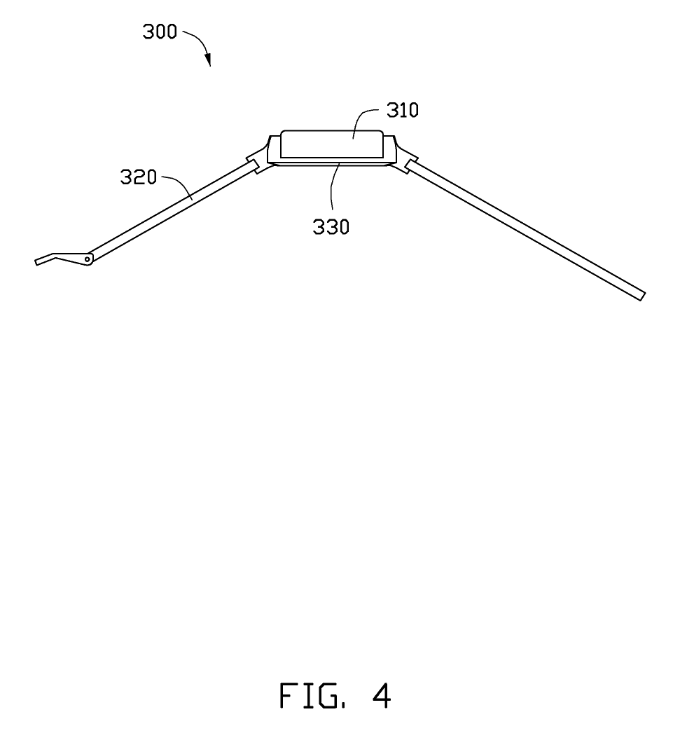

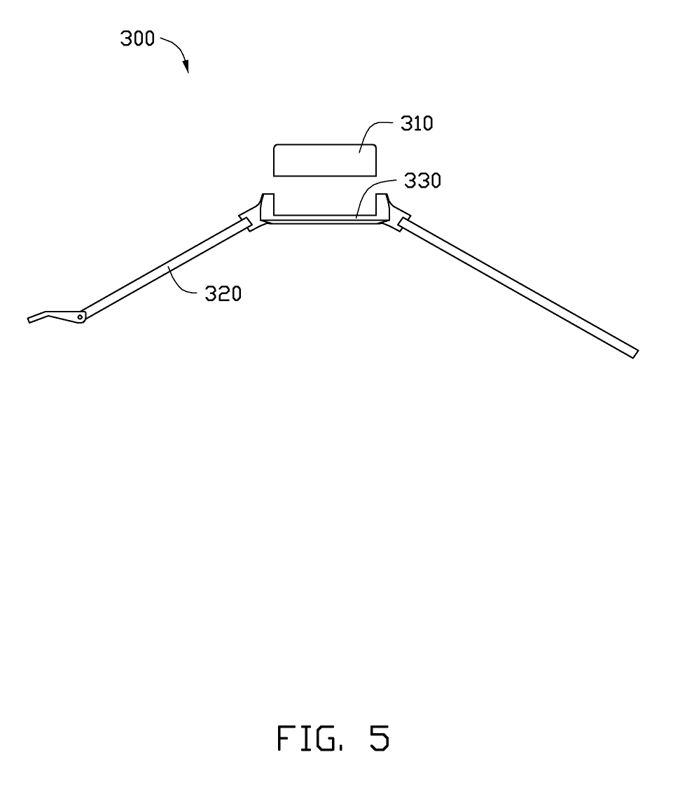

Referring to FIGS. 4 and 5, the watch 300 includes a watch body 310, two watchbands 320, and a watch enclosure 330 connected between the two watchbands 320. The watch body 310 is removably mounted to the watch enclosure 330. The first NFC antenna NFC1, the selecting module 100, and the NFC chip 200 are accommodated in the watch body 310. The second NFC antenna NFC2 is accommodated in one of the two watchbands 320.

In use, when the watch body 310 is received in the watch enclosure 330, the selecting module 100 turns off the connection between the first NFC antenna NFC1 and the NFC chip 200 and turns on the connection between the second NFC antenna NFC2 and the NFC chip 200 via the first resistor R1 and the fourth resistor R4, to allow current from the second NFC antenna NFC2 to flow through the loop with lower resistance. Thus, the watchband 320 accommodating the second NFC antenna NFC2 is capable of communicating with an external device. When the watch body 310 is detached from the watch enclosure 330, the selecting module 100 turns on the connection between the first NFC antenna NFC1 and the NFC chip 200 via the second resistor R2 and the third resistor R3, so that the watch body 310 is capable of communicating with the external device directly.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A watch with wireless communication functions, comprising:
a near field communication (NFC) chip;
a selecting module electrically connected to the NFC chip;
a first NFC antenna electrically connected to the selecting module and configured to communicate with an external device; and
a second NFC antenna configured to be connected to the selecting module and to communicate with the external device; wherein when the second NFC antenna is connected to the selecting module, the selecting module turns on a connection between the second NFC antenna and the NFC chip, and turns off a connection between the first NFC antenna and the NFC chip; and when the second NFC antenna is not connected from the selecting module, the selecting module turns on the connection between the first NFC antenna and the NFC chip.

2. The watch of claim 1, wherein the selecting module comprises a second resistor and a third resistor; the NFC chip comprises a first wireless signal transmitting terminal and a second wireless signal transmitting terminal; a first terminal of the first NFC antenna is electrically connected to the first wireless signal transmitting terminal via the second resistor; and a second terminal of the first NFC antenna is electrically connected to the second wireless signal transmitting terminal via the third resistor.

3. The watch of claim 2, wherein the selecting module further comprises a first resistor and fourth resistor; a first terminal of the second NFC antenna is electrically connected to the first wireless signal transmitting terminal via the first resistor; and a second terminal of the second NFC antenna is electrically connected to the second wireless signal transmitting terminal via the fourth resistor.

4. The watch of claim 3, wherein each of a resistance of the second resistor and a resistance of the third resistor is greater than each of a resistance of the first resistor and a resistance the fourth resistor.

5. The watch of claim 4, further comprising a watch body, two watchbands and a watch enclosure connected to the watch body and the two watchbands; the watch body is movably mounted to the watch enclosure; the first NFC antenna, the selecting module and the NFC chip are accommodated in the watch body; and the second NFC antenna is accommodated in a watchband of the two watchbands.

6. The watch of claim 5, wherein when the watch body is attached to the watch enclosure, the first NFC antenna and the second NFC antenna are both connected to the selecting module, the selecting module turns on the connection between the second NFC antenna and the NFC chip via the first resistor and the fourth resistor, and turns off the connection between the first NFC antenna and the NFC chip via the second resistor and the third resistor, and the watchband accommodating the second NFC antenna is capable of communicating with the external device.

7. The watch of claim 5, wherein when the watch body is detached from the watch enclosure, the first NFC antenna is connected to the selecting module, the second NFC antenna is not connected from the selecting module, the selecting module turns on the connection between the first NFC antenna and the NFC chip via the second resistor and the third resistor, and the watch body is capable of communicating with the external device.

8. A watch with wireless communication functions, comprising:
a near field communication (NFC) chip;
a selecting module electrically connected to the NFC chip;
a first NFC antenna electrically connected to the selecting module; and
a second NFC antenna; wherein the selecting module is adapted to select a connection between the first NFC antenna and the NFC chip or a connection between the second NFC antenna and the NFC chip; and each of the first NFC antenna and the second NFC antenna is capable of communicating with an external device according to the connection selected by the selecting module.

9. The watch of claim 8, wherein when the second NFC antenna is connected to the selecting module, the selecting module turns on the connection between the second NFC antenna and the NFC chip, and turns off the connection between the first NFC antenna and the NFC chip; and when the second NFC antenna is not connected from the selecting module, the selecting module turns on the connection between the first NFC antenna and the NFC chip.

10. The watch of claim 9, wherein the selecting module comprises a second resistor and a third resistor; the NFC chip comprises a first wireless signal transmitting terminal and a second wireless signal transmitting terminal; a first terminal of the first NFC antenna is electrically connected to the first wireless signal transmitting terminal via the second resistor; and a second terminal of the first NFC antenna is electrically connected to the second wireless signal transmitting terminal via the third resistor.

11. The watch of claim 10, wherein the selecting module further comprises a first resistor and fourth resistor; a first terminal of the second NFC antenna is electrically connected to the first wireless signal transmitting terminal via the first resistor; and a second terminal of the second NFC antenna is electrically connected to the second wireless signal transmitting terminal via the fourth resistor.

12. The watch of claim 11, wherein each of a resistance of the second resistor and a resistance of the third resistor is greater than each of a resistance of the first resistor and a resistance of the fourth resistor.

13. The watch of claim 12, further comprising a watch body, two watchbands and a watch enclosure connected to the watch body and the two watchbands; the watch body is movably mounted to the watch enclosure; the first NFC antenna, the selecting module and the NFC chip are accommodated in the watch body; and the second NFC antenna is accommodated in a watchband of the two watchbands.

14. The watch of claim 13, wherein when the watch body is attached to the watch enclosure, the first NFC antenna and the second NFC antenna are both connected to the selecting module, the selecting module turns on the connection between the second NFC antenna and the NFC chip via the first resistor and the fourth resistor, and turns off the connection between the first NFC antenna and the NFC chip via the second resistor and the third resistor, and the watchband accommodating the second NFC antenna is capable of communicating with the external device.

15. The watch of claim 13, wherein when the watch body is detached from the watch enclosure, the first NFC antenna is connected to the selecting module, the second NFC antenna is not connected from the selecting module, the selecting module turns on the connection between the first NFC antenna and the NFC chip via the second resistor and the third resistor, and the watch body is capable of communicating with the external device.
